(19) United States
(12) Patent Application Publication
(10) Pub. No.: US 2004/0068975 A1
(43) Pub. Date: Apr. 15, 2004

(54) Kinetic energy turbine with recuperation

(76) Inventor: Mark Joseph Skowronski, Tustin, CA (US)

Correspondence Address: Mark J. Skowronski, 12165 Glines Court, Tustin, CA, 92782, US

(21) Appl. No.: 10/625,413

(22) Filed: Jul. 23, 2003

Related U.S. Application Data
(60) Provisional application No. 60/399,025, filed on Jul. 29, 2002.

(51) Int. Cl. F02C 7/10

(52) U.S. Cl. 60/39.511

(57) ABSTRACT

Combustion turbines and other types of turbines, whether axial or radial flow, have significant amounts of kinetic energy left in the exhaust gas (working fluid) after the working fluid has been fully expanded to atmosphere. This invention eliminates the exhaust loss typical to both impulse and reaction stages by using externally and rotating nozzles attached to the periphery of the turbine wheel. These nozzles are perpendicular and circumferential to the turbine's centerline. The external rotating nozzles turn the wheel by the production of thrust that create a rotating torque on the turbine's centerline. By controlling the turbine's wheel translational speed to equal the working fluid velocity exiting the nozzle, the exhaust gas (exit) loss is eliminated. In addition, other losses associated with conventional stationary nozzles turbines such as cosine losses, clearance losses and potential “stall” are eliminated. The elimination of these losses allows for high efficiency single stage turbines operating only at the critical pressure necessary to produce sonic velocity in the throat of the nozzle. In this manner the pressure ratio is kept relatively low (at a theoretical 1.89:1 ) which increases efficiency by reducing the proportion of compressor work to gross turbine work. In addition, the efficiency is also increased since the low pressure ratio results in low heat of compression (low temperature at the compressor outlet) and allows for high amounts of recuperation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### REFERENCES CITED

U.S. PATENT DOCUMENTS:

| | | |
|---|---|---|
| 4,141,219 | February 1979 | Froseh et al. |
| 4,430,042 | February 1984 | House |
| 4,441,322 | April 1984 | Ritzi |
| 5,236,349 | September 1993 | Fabris |
| 5,263,313 | November 1993 | Chow |
| 5,413,457 | May 1995 | Tuckey |
| 5,560,196 | October 1996 | Schlote |
| 5,660,038 | August 1997 | Stoner |
| 6,200,094 | March 2001 | Skoch, et al. |
| 6,354,800 | March 2002 | Hays |
| 6,510,683 | January 2003 | Lawlor |

### BACKGROUND OF THE INVENTION

Axial flow turbines, especially combustion turbines, provide motive power for both the generation of electricity and transportation. In addition, many turbines provide direct shaft horsepower for a variety of applications for pumping, manufacturing and compressing stations. The first combustion turbines were used primarily for military aircraft use since they have a high power to weight ratio; these military engines gave way to commercial aircraft in the early 1960's and finally combustion turbines were adapted for power generation in the succeeding decades. Today, small, so called micro turbines, provide electric power in the 25 to 100 kW range and the larger combustion turbines have outputs that exceed 200,000 kW's. The efficiency of these machines range from the mid twenty percent range to the low forty percent (lower heating value); typically, the smaller machines are less efficient than the larger machines. Due to today's volume manufacturing, the combustion turbines can be relatively inexpensive when compared to similar sized alternate methods of providing power or electricity.

The efficiency of combustion turbines still, generally, lag behind the internal combustion engines of similar size. Of course, any improvement in efficiency is desired since this reduces the operating cost of the machine. A base loaded (7×24) combustion turbine will normally consume a present worth value of fuel that is several times its installed cost.

Accordingly, more efficient machines are always beneficial assuming that the cost to improve the efficiency is justified by the fuel savings.

Small combustion turbines tend to be costly ($/kW) and typically have poor efficiencies; this is especially true of small axial flow machines. The inefficiencies are the result of:

More pronounced boundary layer phenomena acting on the blades;

Higher proportional clearance losses; and,

Higher proportional exhaust losses resulting from fewer stages.

In particular, high exhaust losses can be very significant in single stage axial flow turbines. The theoretical velocity of the working fluid exiting from a pure impulse stage is 0.5 Mach number; given that the exhaust loss is proportional to the square of the gas velocity, these losses can be very detrimental to turbine performance.

Reaction turbines may have lower exit velocities (exhaust losses) but generally must be operated at higher pressure ratios in order to extract maximum energy. Higher operating temperature normally dictates higher pressure ratio to achieve maximum efficiency. By contrast, an impulse turbine only needs a theoretical 1.89:1 pressure ratio (PR) to achieve sonic velocity at the nozzle; this pressure ratio is independent of the operating temperature (for single stage applications). A single stage impulse machine that can eliminate its own exhaust loss and operate at a low PR can be shown to have significantly higher efficiencies than a comparable reaction turbine when operated at the same turbine temperature and both are recuperated.

### Description of Current Turbine Technology

Typically, the first stage in an axial flow turbine is impulse, or mostly impulse, in order to reduce the pressure and temperature of the working fluid as rapidly as possible and reduce the stress and temperature (and cost) of subsequent staging. After the high pressure working fluid (gas) is heated in the combustor, the gas is directed to a nozzle (“stationary” blading) where sonic velocity is produced for impingement of the blade (“rotating” blading). It is this moving blade (force times distance) that results in thermodynamic “work” being performed by the rotating blade. Maximum energy is extracted when the rotating blade is moving at ½ sonic velocity that results in an exit velocity of the working fluid of ½ Mach number (as seen from a stationary observer). With multiple staging, the exhaust “loss” in the form of a dynamic or velocity “head” in the first impulse stage is merely reconstituted into static head and redirected to the second stage nozzles. This process is repeated until the last stage when the fluid velocity exits normally in the range of 0.35 to 0.45 Mach number (prior to diffusion).

As the number of stages is reduced and the amount of work extracted from the working fluid is reduced, the proportional exit loss (kinetic energy) becomes more pronounced relative to the overall output of the turbine. When the turbine is reduced to a single stage, the theoretical exit loss for an impulse stage is 25% of gross (discounting temperature changes) and can be calculated with the simple formula:

Kinetic Energy=½MV²

where “M” is the mass flow rate of the working fluid and “V” is the velocity of the gas. Since the theoretical exit velocity is 0.5 Mach number, this represents an exit loss of 25%, i.e. 0.5²=0.25 or 25% loss. Any change of a combustion turbine's gross output is magnified against its net output. This is because combustion turbines have high “back work” requirements; the compressor in a Brayton cycle can consume 50 to 75% of the turbine's gross output. For example, if a compressor consumes 70% of the gross turbine output, then increasing the gross turbine output by 30% will result in a 100% increase in the turbine's net output Accordingly, by incorporating a 30% exit loss back into the turbine's gross output will significantly increase the net output.

### BRIEF SUMMARY OF THE INVENTION

This concept directly uses the kinetic energy in the mass flow rate of the working fluid and does not require “staging” to yield high thermal efficiency. This invention is characterized by a Brayton cycle that incorporates the turbine exhaust losses into useful turbine work; low pressure ratio resulting in low compressor work; and, high recuperation resulting from the low heat of compression. The concept described is called the Recuperated External Impulse Turbine (REIT). Although the concept can be configured for multiple staging, maximum benefits are achieved using single stage (or parallel stages) operating at the same critical pressure ratio. Such turbines, in the range of several kW's to, perhaps, up to several megawatts in size could be used in a wide variety of uses including motive power that is currently provided by reciprocating engines and microturbines. In addition, larger machines could be fashioned merely by adding parallel wheels to the same shaft all operating at the same pressure. In addition, multiple stages could also be used.

The REIT concept incorporates a turbine wheel that is powered by external rotating nozzles located on the periphery of the wheel. The wheel is rotated by the reaction of these nozzle(s) acting on the outer peripheral of the wheel providing thrust and resulting rotating torque that is applied to the turbine shaft and spins the wheel. The nozzles emit the working fluid at, or close to, sonic velocity to provide maximum thrust. By using the kinetic energy directly, the turbine stage is greatly simplified and made more efficient by the elimination of the “moving blade” stage indigenous to multi staged axial flow machines. Conventional impulse turbines use a fixed nozzle that impinges the thrust of the nozzle unto a moving blade.

Conventional turbines limit the blade speed to ½ of the nozzle exit speed and produces high exit losses since the working fluid exits the moving blade at the same speed it enters (½ of the nozzle exit speed). The REIT turbine wheel incorporating the external rotating nozzle concept rotates at the translational speed equal to the sonic velocity of the nozzle discharge. In this manner, the exit losses of the working fluid have been eliminated. By comparison, a conventional pure impulse stage has working fluid leaving the blade and a theoretical 0.5 Mach number resulting in a high kinetic energy loss.

The REIT operates on a conventional recuperated or non-recuperated Brayton cycle and has the same Temperature-Entropy diagram as a conventional Brayton cycle that uses impulse, reaction and combination impulse/reaction type staging. However, by eliminating the exit losses resulting from the high velocity exiting gas from a conventional turbine, a single stage, low pressure ration turbine with high efficiency turbine cycle can be built. The low pressure ration allows for higher amounts of recuperation that further increases the efficiency of the REIT cycle.

The REIT cycle turbine wheel is far simpler than a conventional impulse stage and is far more flexible in application. Depending on the needs of the application, one wheel design can be adapted for a wide range of power outputs by varying the number of nozzles and the throat diameter in the nozzles of a common designed REIT turbine wheel.

It is most important to identify the fact that the net turbine output can be increased by higher turbine (nozzle) temperature but the pressure ratio always remains the same (critical pressure ratio of 1.89:1); accordingly, the compressor work always remains the same. This results in unusually high efficiencies more closely approximating Carnot since any differential increase in gross turbine output is added to the net output as no additional work of compression is required.

### BRIEF DESCRIPTION OF THE DRAWINGS

FIG. 1 is a cycle schematic depicting the major components of the invention. The compressor is shown along with the novel turbine wheel utilizing external rotating nozzles. The cycle also shows a combustor, recuperator and the primary ducting to effect a working system. This schematic is representative of a generic Brayton cycle utilizing recuperation. The novelty of this invention is the turbine wheel that eliminates exit losses, other nozzle losses and minimizes work of compression and increases the effectiveness of recuperation.

FIG. 2 is drawing of the REIT's turbine wheel highlighting the rotating external nozzles. This type of wheel is commonly referred to as a “Hero's wheel” first demonstrated over 2,000 years ago; however, the novelty of this concept is to use this wheel in a Brayton cycle to eliminate certain nozzle losses and wheel exit losses.

FIG. 3 is a side view of the REIT's turbine wheel and how the wheel is connected to the turbine through a gear box. Alternately, a high speed generator could be used in conjunction with an inverter.

FIG. 4 is a schematic representation of the thrust vector and the translational velocity of the wheel. When these two vectors are additive to zero (0) then the exit loss has been eliminated and maximum wheel efficiency results.

FIG. 5 is a summary table that shows the losses incurred and the resulting work of both compressor, turbine and the net shaft work output.

FIG. 6 is chart that shows approximated REIT's cycle efficiencies at various turbine inlet temperatures with assumed losses included.

FIG. 7 is a schematic that shows the manner of multiple wheels operating at the same pressure ratio. In addition multiple sequential or pressure cascaded stages could also be used. In this configuration, pressure would be staged similar to conventional multi-staged turbines.

### DETAILED DESCRIPTION OF THE INVENTION

The Description of the Preferred Embodiment is divided into four parts to more fully describe the novelty. These four parts are:

Description of cycle process; this section uses drawings and figures to more fully detail the REIT cycle process;

Factors for Optimal Performance; this section highlights the primary factors that characterizes the REIT cycle.

Summary of the REIT's Turbine's Advantages; this section delineates the primary reasons why the REIT is superior to conventional Brayton cycles.

Sample Calculations; this section gives a “step by step” approach to illustrate the advantages of the REIT cycle. These sample calculations are based on assumed operating criteria with realistic and conservative assumptions with regard to losses and component efficiencies.

### Description of Cycle Process

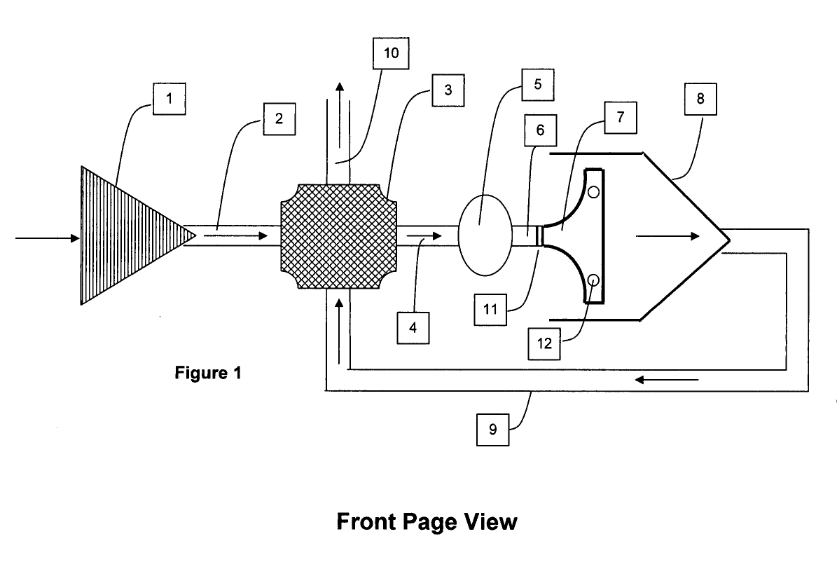

Referencing FIG. 1, the overall cycle is described in schematic fashion. Air is pressurized by a compressor 1 to the theoretical “critical” pressure ratio (1.89:1) required to produce sonic velocity in a nozzle. Over pressurization results in the nozzle being “choked” and merely adds unnecessary compressor work to the cycle. After allowing for system losses, the recommended pressure ratio is approximately 2.3:1. The compression heated and pressurized gas 2 is then routed through ducting to be preheated in the recuperator 3. In a recuperated Brayton cycle, the thermodynamic efficiency is significantly enhanced by increasing the working fluid temperature to the combustor. After the gas 4 is preheated in the recuperator 3, further heat is added by the addition of fuel in the combustor 5. The pressurized and heated working fluid 6 is then directed to the rotating wheel 7 where the heated pressurized mixture of fuel and air (working fluid) 6 is routed to the nozzles 12 located on the rotating wheel 7 periphery. Alternately, internal ducting and baffles may direct the flow to the nozzles 12. Such ducting to the nozzles is sized to minimize gas flow velocity and accompanied losses. The nozzles 12 then convert the pressurized and heated gas into high velocity gases approaching Mach number 1.0. The kinetic energy of exiting gases resulting from the nozzle 12 provides the thrust and resulting torque to spin the wheel. After the exhaust gas exits at near atmospheric pressure, a collector 8 is used to gather the heated exhaust for the subsequent recuperation of heat.

After expansion in the external rotating nozzles 12 located on the rotating turbine wheel 7, the exhaust gases 9 are routed to the recuperator 3 where the waste heat of the rotating turbine wheel 7 is used to preheat the compressed air 2. The spent working fluid 10 is then exited to the atmosphere.

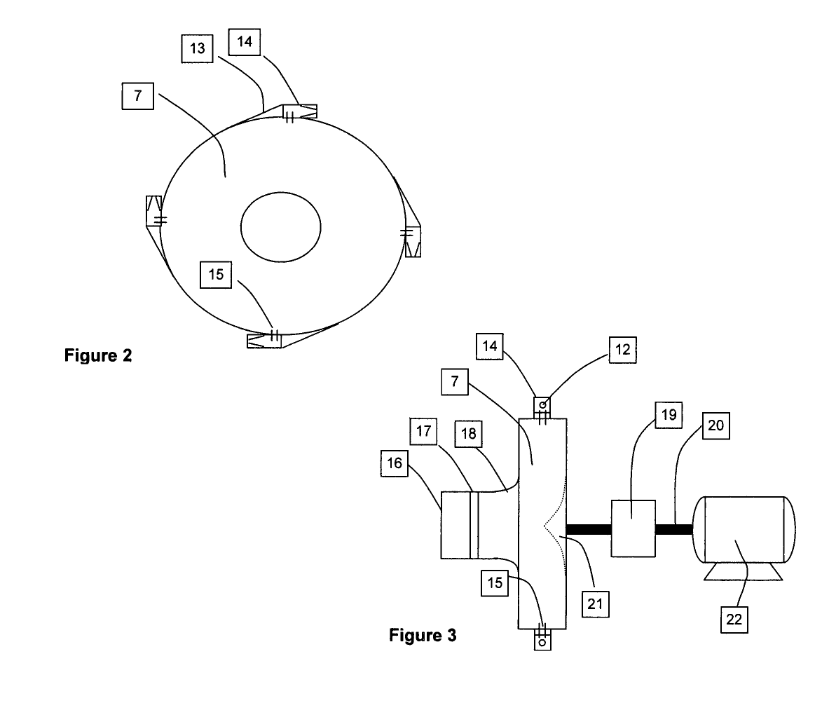

Referencing FIG. 2, a more detailed drawing of the rotating turbine wheel 7 is shown. As noted, the nozzle blocks 14, which contain the nozzles 12, are shown attached to the rotating turbine wheel's 7 outer periphery. Aerodynamic runners 13 are used to minimize windage losses. Alternate designs may use a totally enclosed nozzle 12 to further reduce windage. The hollow rotating turbine wheel 7 supplies the working fluid to the nozzle through the nozzle inlet 15 by providing passage from inside of the rotating wheel 7 to the nozzle 12 inlet. Alternate nozzle designs may use elongated nozzles in order to provide higher flow output resulting in higher turbine output. These elongated nozzles would result in a more “barrel” shape configuration for the wheel 7. Referring to FIG. 8, such a design is illustrated whereby the elongated wheel 27 has elongated nozzles 28.

Referencing FIG. 3, a side view of the rotating turbine wheel 7 is shown. The working fluid 6 enters the stationary duct 16, which is connected, to a rotating seal 17. The rotating seal 17 allows the turbine inlet duct 18 to spin freely with the rotating turbine wheel 7. Bearings, both thrust and radial are not shown but will be needed to allow the turbine wheel 7 to spin at high speed. In order to reduce the friction loss and to more accurately direct the working fluid 6 to the nozzles 12, baffles 21 may be used to minimize pressure losses.

FIG. 3 shows the rotating turbine wheel 7 connected to a gear box 19 to allow connection to a standard 1,800 or 3,600 rpm generator 22. Alternately, a direct coupled high speed generator could also be used in conjunction with an inverter.

### Factors for Optimal Performance

The REIT cycle can be designed to be significantly more efficient (and less expensive) than comparable single stage combustion turbines because of several factors.

1. Translational speed of the Rotating Wheel;

2. Pressure ratio, temperature and the impact of recuperation; and,

3. Wheel design.

1. Rotating Turbine's Translational Speed and Working Fluid Exit Velocity

The most critical factor in achieving a high recovery of the kinetic energy in the working fluid 6 is the matching of the translational rotational speed of the rotating turbine wheel 7 and the exiting velocity of the working fluid from the nozzle 12. Presently, a stationary turbine experiences a 100% loss of the high velocity exiting (exhaust) gases since no work is performed. With a REIT turbine, the rotating wheel 7 rotates with a translational speed equal to the speed of the exiting gases in order to produce optimum recovery of the kinetic energy in the gases. Accordingly, there is no theoretical exhaust loss using a REIT rotating wheel 7. As previously discussed, conventional impulse turbine loses (theoretically) the kinetic energy in the exhaust gas that is moving at 0.5 Mach number; this kinetic energy loss amounts to 25% of total energy delivered to the impulse turbine wheel (i.e. 0.5²=0.25).

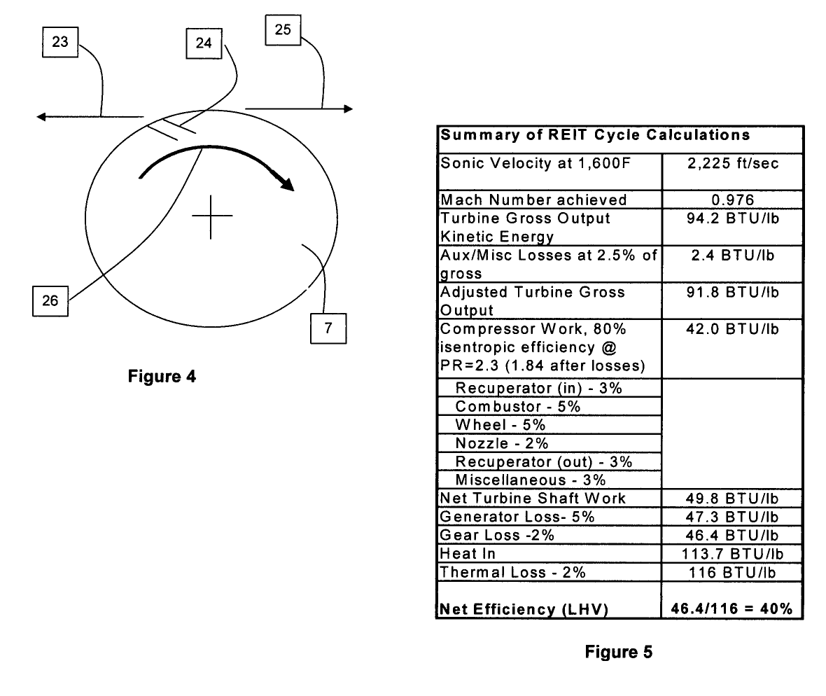

The REIT turbine cycle eliminates the exhaust loss because “velocity” and “thrust” are vectors that have both direction and magnitude. These vectors are shown schematically in FIG. 4. The horizontal thrust vector 23 equals the translational velocity vector 25. Accordingly, if the translational speed of the wheel and the velocity of the exit gas are the same, then the addition of the horizontal thrust vector 23 and the translational velocity vector 25 equals zero and produces a zero exhaust loss. As the turbine wheel 7 slows and approaches zero rotations, then the high speed gases exiting the nozzle 12 become more and more of an exhaust loss. At zero rotations, the exit loss (kinetic energy) is 100% and similar to the exhaust losses now experienced by the high velocity gasses exiting the last stage of a stationary conventional gas turbine.

The rotating turbine wheel 7 speed is easily calculated since the translational speed is (theoretically) the same as the sonic speed (Mach number 1.0) of the heated gas after expansion in the nozzle. The following example calculates the approximate speed of a 12 inch diameter REIT turbine wheel when operated at 1,389F (1,849R) based on a nozzle entry temperature of 1,700F (2,160R):

c=Sonic Velocity=(k*g*R*T)^{1/2}

Where

k=1.4

g=32.2

R=53.3

T=1,849 (Rankine)

Therefore Sonic Velocity=(1.4*32.2*53.3*1,849)^{1/2}=2,108 ft/sec

Since the translational velocity of the rotating turbine wheel is:

Velocity=2Pi*Radius*Rotation

Therefore, solving for the rotational speed=40,276 RPM

In order for optimum performance to be achieved, the translational velocity of the wheel must be maintained at the gas velocity. Exceptional part load performance can be established if the operating temperature of the gas is varied with the wheel speed such that the translational velocity of the wheel always equals the velocity of the nozzles jet.

2. Pressure Ratio, Temperature and the Impact of Recuperation

In a conventional reaction turbine, an increase in turbine inlet temperature must be accompanied by an increase in the pressure ratio in order to produce the maximum extraction of energy from the working fluid and to produce the highest efficiency. Thermodynamically, this is referred to as increasing the availability of the cycle. However, in the REIT turbine cycle, this is not the case. The REIT cycle operates on a fixed and very low pressure ratio regardless of the turbine inlet temperature; all that is required is the critical pressure ratio to produce sonic velocities in the nozzles. The higher turbine output resulting from increased operating temperature, without increasing the pressure ratio beyond critical, is based on the nuance that the critical pressure ratio is independent of temperature. One expression for determining the critical pressure is given as:

(P₂/P₁)_{c}=(2/(k+1))^{k/(k-1)}

where: (P₂/P₁)_{c} is the critical pressure ratio;

and k is the ratio of specific heats (1.4 for air); solving:

(P₂/P₁)_{c}=(2/2.4)^{1.4/4}=0.528

Accordingly, when P₁/P₂ is equal to or greater than a pressure ratio of 1.89 (1/0.528), sonic velocity occurs in the nozzle's throat. Higher pressure ratio merely “chokes” the nozzle and would cause unnecessary auxiliary losses to the cycle.

Therefore, once the critical pressure ratio is achieved, the working fluid temperature can be raised prior to nozzle entry. The increased temperature results in higher working fluid velocity (but at the same Mach number) and higher kinetic energy at the nozzle discharge. Restating the relationship between sonic velocity and temperature:

c=(k*g*R*T)^{1/2}

where

c=sonic velocity (ft/sec)

k=ratio of specific heat (1.4)

R=universal gas constant (53.3)

T=degrees Rankine

Therefore, at constant Mach number 1.0, the sonic speed of the working fluid is shown to increase proportionally to the square of the temperature increase. And since kinetic energy=½*M*V², then the energy increase is proportional to the square of the gas velocity. Note, the actual calculation to determine the wheel output must use temperature corrected values for specific heat (Cₚ) and the ratio of specific heats (k). This has been done in the sample calculations following.

3. Wheel Design

The basic design of the REIT rotating turbine wheel 7 is merely a spinning hollow disk with nozzles at the periphery of the wheel oriented in such a manner that the thrust produces a moment around the axis resulting in rotating torque on the axis. A wheel of 18 inch diameter could be used for a 5 kW turbine or a 100 kW turbine merely by adding additional nozzles and by increasing the nozzle's throat area. A small output machine might have two nozzles with ⅛ inch throat diameter. However, by adding two more nozzles on the periphery and by increasing the nozzle throat diameter to ⅜ inch, the turbine wheel's gross output is increase by 18 times. The higher output results from increasing the nozzles number by a factor of two and by increasing the working fluid through put by a factor of 9, i.e. 2×9=18. The REIT design greatly simplifies wheel sizing and allows the concept to be used in multiple ways without the necessity and cost of new wheel designs.

Another important design feature of the REIT concept is the self-cooling inherent in the design of the wheel. Referring to FIGS. 2 and 8, once the working fluid (assumed at an operating temperature of 1,700F (2,160R)) is ejected from the nozzles, the gas, having expanded through the critical pressure ratio, is now 311F cooler. Consequently, the inside of the wheel is 1,700F but the outside surface is bathed in gases at 1,389F; consequently, the wheel is self-cooled from the “outside-in” as opposed to conventional blades which are cooled from the “inside-out”. The self cooling allows the wheel to operate at higher operating temperatures than otherwise would have been metallurgical limited.

### Summary of the REIT Turbine's Advantages

The REITS turbine cycle produces significant thermodynamic cycle improvement when compared to a conventional Brayton cycle since:

The amount of compressor work is the same regardless of the REIT cycle operating temperature, i.e. an increase in the REIT's cycle operating temperature results in additional turbine output does but not require additional compressor work.

The low pressure ratio results in a low compressor exit temperature and this allows for higher recuperation rates when compared to cycles with higher pressure ratios. A low pressure ratio recuperated turbine cycle more closely approximates the Carnot cycle and improves cycle efficiency.

Since the translational speed of the wheel equals the speed of the exiting gases, there is no exhaust loss and other associated nozzle losses; conventional single stage impulse turbines have a theoretical exhaust loss of 25%, and, in practice, the overall losses including other nozzle losses may be even higher.

The REIT wheel is self cooled allowing for higher operating temperatures when compared to conventional non-cooled blades.

### Sample Calculation of the REIT Cycle

A sample calculation of the REIT cycle is described in this section. Specific attention is paid to internal process losses incurred since the Brayton cycle and REIT cycle are both very sensitive to these types of system degradation. Thermodynamically, when depicted on a TS diagram, the REIT cycle is similar to a recuperated Brayton cycle and is just as susceptible to system losses. Accordingly, low component efficiencies and system losses have very significant and detrimental impacts on the overall cycle efficiency. This sample calculation takes realistic, and in some cases, conservative estimates of system losses. System losses can be categorized into three areas:

1. Compressor Losses;

2. Cycle Losses; and,

3. Production Losses.

Compressor Losses

The compressor losses represent those losses that require the compressor to operate at a higher pressure ratio such that when the working fluid reaches the turbine inlet, the correct pressure is realized. In other words, the working fluid will suffer a degradation of pressure as it “winds” its way through the system from the compressor outlet to the exhaust outlet. These losses are identified as follows:

Recuperator (low temperature in)—3%

Combustor—4%

Wheel loss—2%

Recuperator (high temperature out)—3%

Miscellaneous/Other—2%

Cumulatively these losses are:

3+4+2+3+2=14%

Consequently, the compressor must pressurize the air to a value that is approximately 14% higher than the delivery pressure to the turbine , or in the case of the REIT's cycle, to the nozzles. In addition, the assumption is also made that the overall isentropic compressor efficiency is 80%. Due to the low pressure ratio required, an 80% isentropic efficiency compressor is readily available; higher compression ratios generally result in lower compressor efficiencies due to higher entropy and clearance losses associated with higher compression.

Cycle Losses

Cycle losses are defined as those losses that impact the overall or gross output of the turbine. These losses can be categorized as:

Windage—1.5%;

Nozzle losses—2% (Nozzle Cv=0.98);

Auxiliary and miscellaneous losses—1.5% (about 3% of net output); and,

Thermal losses—5%

External losses due to windage can be expected. The 1.5% estimate for windage is based upon the work of Ramgen. This is a company that is developing a similar technology whereby the compressor and combustor are both located on the outer periphery of the wheel. In addition, previous windage losses for “disk” rotating in enclosed spaces where explored in the technical papers “Daily, J. W. et al. 1960”; and “Zimmerman, et al. 1986”.

The nozzle, of course, isn't a perfect device and there will be an energy loss associated with the conversion of enthalpy into velocity. These losses result from the nozzle's inefficiency. Although critical pressure may exist across the nozzle, the inefficiency of the nozzle will result in less than sonic velocity at its exit. Previous experiments by turbine manufactures (Warren and Keenan, Trans. ASME, 48, p. 33) indicate that energy reduction is normally less than 2%, i.e. the nozzle's C_{V} is greater than 0.98. Accordingly, for purposes of evaluation, the REIT's nozzle is assumed to suffer a 2.0% reduction in nozzle energy.

Auxiliary and miscellaneous losses include mechanical, auxiliary and cooling fan losses and are subtracted from the gross output of the turbine; they are estimated at 1.5% of turbine gross output (approximately 3% of net).

The thermal loss is the amount of heat that escapes from the process equipment. Although obviously insulated, losses will still occur. Due to the larger recuperator for the REIT cycle, this loss is estimated to be 5%; conventional, non-recuperated turbines have around 2-3% loss. This loss is accounted in the heat added to the cycle, i.e. the calculated, theoretical amount heat required for the cycle is multiplied by a factor of 1.05.

Production Losses

Production losses are defined as those losses incurred when the energy from the wheel is transformed into electrical energy. These losses primarily consist of:

Generator loss—3% (Assuming synchronous generator for 5 MW machine)

Gear box loss—2%

### Sample Calculation

Work of Compression

In order to evaluate the REIT cycle, the first calculation is the determination of the compressor work required to produce critical pressure (1.855:1) at the nozzle temperature of 1,700F. The compressor work can be determined by calculating the isentropic end point temperature after compression and then adjusting for compressor efficiency. Accounting for the “Compressor Losses” (14%) described above and assuming that the compressor will have an 80% isentropic efficiency, a 2.11 pressure ratio is assumed (1.14*1.855=2.11). An expression to determine the isentropic temperature after compression can be given as:

P₂/P₁^{(k-1)/k}=T₂ₛ/T₁

Where T1 is the ambient temperature (520R) and T₂ₛ is the isentropic temperature end point after compression.

Solving for T₂ₛ:

T₂ₛ=520*2.11^{(1.4-1)/1.4)}=644R

At 80% isentropic efficiency:

0.8=(T₂ₛ−T₁)/(T₂−T₁)

Solving for T₂:

T₂=(644−520)/0.8+520=675R

Work of compression=h₂−hᵢ=Cp(T₂−T₁)=0.24(675−520)=37.2BTU/Lbₘ(W_{c})

Work of Turbine

In order to calculate the kinetic energy produced by the nozzle, the ratio of specific heats (k) must be calculated at both the operating temperature and exit temperature. First find Cₚ at operating temperature:

M_{w}*Cₚ=9.47−3.47*10³/T(R)+1.07*10⁶/T²(R)

Where M_{w} is the molecular weight of 28 and T is 2160R

Solving: Cₚ=0.272

Knowing Cp allows the determination of “k” since:

Cₚ=k/(k−1)*R/778

Where R is the gas constant at 53.3;

Solving: k=1.337

The exit temperature can now be calculated from:

T_{critical=}2/(k+1)*T

Solving: T_{critical}=1,849R

Since there are no exit losses, (i.e. resulting from the translational velocity of the wheel equaling the gas velocity exiting the nozzle), and no other losses associated with a moving blade, the energy produced by the nozzle equals the work produced by the wheel. The sonic velocity (c) is determined at the exit conditions of the nozzle and is based on the exit temperature of 1,849R. By similar methods shown above, a new ratio of specific heats “k” is derived based on the exit temperature; the new calculated “k” value is 1.359 (at Cₚ=0.259). Accordingly, the sonic velocity can be determined from the following relationship:

c=Sonic Velocity=(k*g*R*T)^{1/2}

Where k=1.359 (ratio of specific heats)

g=32.2 (gravity constant)

R=53.3 (gas constant)

T=1,849 (Rankine)

Sonic Velocity c=(1.359*32.2*53.3*1,849)^{1/2}

Solving for c=2,077 ft/sec

The kinetic energy produced by the wheel is:

Kinetic Energy (KE)=½*M*V²

Where M is the mass flow rate and V is the velocity in ft/sec

Putting the expression on a BTU/lbm basis:

KE/M=½*V₂

Solving:

KE/M=BTU/lbm=½*2077²/(32.2*778)=86.1BTU/lbₘ gross turbine output

Subtracting turbine (cycle) losses of:

1. auxiliary and miscellaneous losses of 1.5% of gross (1.3 BTU/lbₘ);

2. nozzle losses at Cᵥ=0.98 (1.7 BTU/lbₘ); and,

3. Windage losses at 1.5% (1.3 BTU/lbₘ)

Total turbine losses of 4.3 BTU/lbₘ yields net output of 86.1−4.3=81.8 BTU/BTU/lbₘ

The amount of compressor work is subtracted from the corrected gross turbine output to yield net shaft work:

Solving:

81.8−37.2=44.6BTU/lbₘ net turbine shaft output

The production losses (3% synchronous generator and 2% gear box losses) are subtracted from the net turbine work.

Solving:

44.6*0.97*0.98=42.4BTU/lbₘ (net electrical equivalent output)

The recuperator approach temperature (pinch point) is assumed to be 65 F. Accordingly, the total amount of heat added to the cycle (including a 5.0% thermal loss) is based on the enthalpy of the gross turbine output plus the heat required to continue heating the working fluid to its operating temperature once it exits the recuperator. A Cp is calculated at 0.27 to determine the heat addition of the combustor.

Solving for Q (heat added to cycle):

Q=1.05*[86.1BTU/lbₘ+0.27*65]=108.9BTU/lbₘ total heat input to cycle

The net thermal efficiency is defined as the net work divided by the heat added to the cycle.

Solving:

(42.4/108.9)*100=38.9% (net thermal efficiency−LHV)

These sample calculations are summarized on FIG. 5.

### Other Embodiments of the REIT's Turbine Cycle

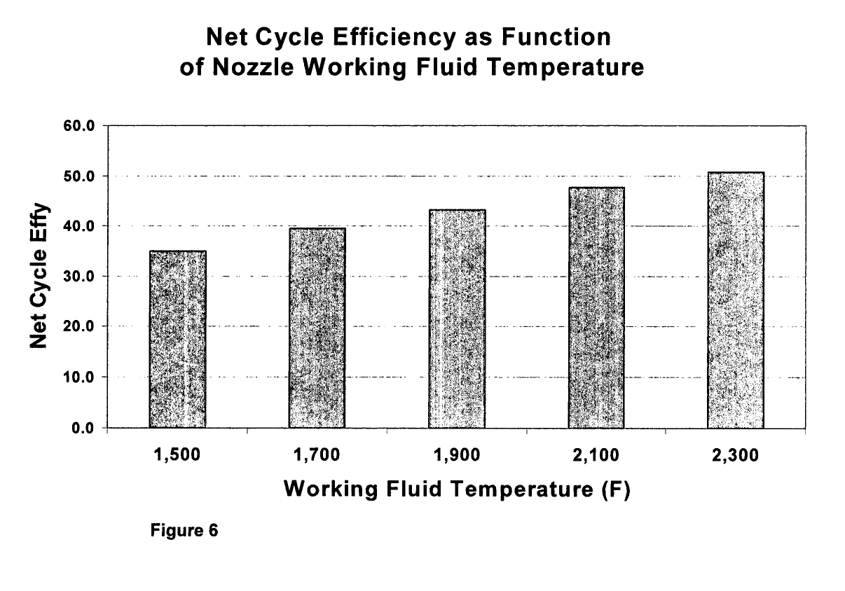

By boosting the operating temperature of the working fluid, significant increases in both the amount of net work (BTU/lb) and net efficiencies result. These increases do not require an increase in the pressure ratio and therefore no additional compressor work is charged against the net output. A traditional Brayton cycle will normally have an impulse (or mostly impulse) first stage to reduce the pressure and temperature of subsequent stages, however, these stages are normally reaction type blading. Accordingly, boosting the working fluid operating temperature will require additional pressure (i.e. availability) in order to maximize the advantages of operating at higher temperatures. As noted on FIG. 6 (chart), the REIT cycle shows significant increases in performance merely by boosting the working fluid temperature. The chart shows net efficiencies and corresponding specific work in BTU/lb. This chart is based on the losses and assumptions previously described in the Sample Calculations and shows only the net impact of higher operating temperatures.

The REIT cycle does not necessarily have to be recuperated nor is it limited to sonic and subsonic applications. In particular, a converging-diverging nozzle could be used to produce the same effect as the sonic/subsonic REIT cycle. However, supersonic designs of the REIT cycle would be more complex and require wheel speeds commensurate with the supersonic gas velocities.

REIT cycles in a non-recuperated version could be used where low cost and moderate efficiencies are required, however, the elimination of the recuperator would significantly reduce the overall efficiency of the cycle and eliminate a prime advantage of the REIT cycle, i.e. its low pressure ratio increases the effectiveness of recuperation.

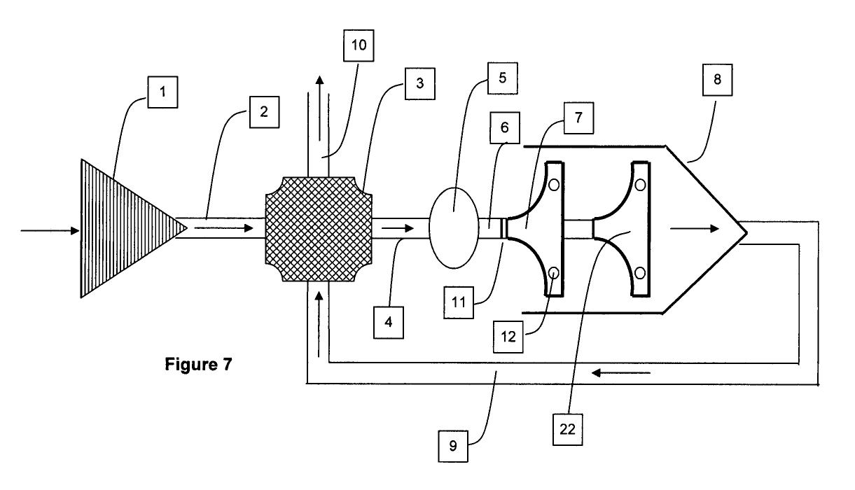

Added power output could be accomplished by using multiple wheels attached to a single shaft with all wheels operating at the same critical pressure. The concept of multiple wheels utilizing the same pressure is illustrated in FIG. 7 that shows the addition of a rotating turbine wheel 22. In similar fashion, additional wheels could also be added.

Staging which is the concept of having sequential turbine wheels operating at different pressures could also be used. In this concept, the pressure is cascaded, i.e. one wheel operates at a certain pressure then subsequent wheels operate at lower pressure with each stage operating at the theoretical critical pressure ratio to achieve sonic velocity in the wheel's nozzles.

What is claimed is:

1. The use of a turbine wheel using a rotating nozzle or nozzles located on the wheel's periphery in a simple Brayton cycle.

2. The use of a turbine wheel using a rotating nozzle or nozzles located on the wheel's periphery in a recuperated Brayton cycle.

3. The use of a turbine wheel which uses rotating nozzle or nozzles and such turbine wheel having a translational speed equal to or nearly equal to the velocity of the working fluid exiting from the nozzle or nozzles to eliminate or mostly eliminate kinetic energy exhaust losses and associated losses which result from stationary nozzles.

4. The use of multiple turbine wheels incorporating claims 1,2, or 3 when operated at the same pressure.

5. The use of multiple turbine wheels incorporating claims 1,2, or 3 when operated at cascading pressures.

6. The Claims of 1, 2, 3, 4, or 5 when used in conjunction with one or more sonic or supersonic nozzles.

7. The use of a turbine wheel or wheels of claims 1, 2, 3, 4, 5, or 6 to be cooled resulting from cooler working fluid gases expanding from the nozzle and surrounding the outside of the turbine wheel or wheels.

8. The use of a rotating seal or seals to allow the turbine wheel or wheels of claims 1, 2, 3, 4, 5, or 6 to rotate independent of the shaft.

9. The use of a varying diameter wheel to match translational velocity of the wheel to the exit speed of the gasses leaving the nozzle(s).

10. The use of multiple nozzles on the same diameter wheel to allow for different output capacities.

11. The use of different sized nozzles on the same diameter wheel to allow for different output capacities.
